(19) United States
(12) Patent Application Publication
(10) Pub. No.: US 2005/0222363 A1
(43) Pub. Date: Oct. 6, 2005

(54) Segmented polyurethane hotmelt adhesives

(76) Inventors: Michael Krebs, Hilden (DE); Uwe Franken, Dormagen (DE); Christoph Lohr, Mettmann (DE)

Correspondence Address: HENKEL CORPORATION, THE TRIAD, SUITE 200, 2200 RENAISSANCE BLVD., GULPH MILLS, PA, 19406, US

(21) Appl. No.: 11/042,742

(22) Filed: Jan. 24, 2005

Related U.S. Application Data
(63) Continuation of application No. PCT/EP03/07968, filed on Jul. 22, 2003.

(30) Foreign Application Priority Data
Jul. 31, 2002 (DE) 102 35 090.6

(51) Int. Cl. C08G 18/00

(52) U.S. Cl. 528/44

(57) ABSTRACT

A reactive hotmelt adhesive is prepared which contains a reaction product of a stoichiometric excess of a polyisocyanate with a hydroxyl-functional polyester-ether block copolymer based on aromatic dicarboxylic acids. The adhesive additionally contains a reaction product of a polyisocyanate and at least one of either a polyether polyol or a polyester polyol. A thermoplastic polymer may also be present.

### CROSS-REFERENCE TO RELATED APPLICATIONS

This application is a continuation under 35 USC Sections 365(c) and 120 of International Application No. PCT/EP2003/007968, filed 22 Jul. 2003 and published 12 Feb. 2004 as WO 2004/013199, which claims priority from German Application No. 10235090.6, filed 31 Jul. 2002, each of which is incorporated herein by reference in its entirety.

### FIELD OF THE INVENTION

The present invention relates to reactive polyurethane hotmelt compositions on the basis of polyether- and/or polyester-based prepolymers containing isocyanate groups and also of reactive segmented block copolymers.

### DISCUSSION OF THE RELATED ART

Reactive polyurethane adhesives and sealants based on prepolymers containing free isocyanate groups are distinguished by a very high performance profile. This has increasingly enabled new applications to be opened up in recent years for these adhesives/sealants. Compositions for such adhesives and/or sealants are already known from a very large number of patent applications and other publications. Such compositions include, in particular, reactive, one-component, moisture-curing polyurethane hotmelt adhesives.

These adhesives are solid at room temperature and are applied as an adhesive in the form of their melt; the polymeric constituents of the polyurethane hotmelt adhesives contain urethane groups and also reactive isocyanate groups. The cooling of this melt after application and joining of the substrate parts to be connected results first in a rapid physical setting of the hotmelt adhesive, by virtue of its solidification. This is followed by a chemical reaction of the isocyanate groups still present with moisture from the environment, to form a crosslinked unmeltable adhesive. Reactive hotmelt adhesives based on isocyanate-terminated polyurethane prepolymers are described for example by H. F. Huber and H. Müller in “Shaping Reactive Hotmelts Using LMW Copolyesters”, Adhesives Age, November 1987, page 32 to 35.

Laminating adhesives either can have a construction similar to that of the reactive hotmelt adhesives or are applied as one-component systems from solution in organic solvents. Another embodiment is composed of two-component solvent-borne or solvent-free systems, in which the polymeric constituents of one component contain urethane groups and also reactive isocyanate groups and the second component comprises polymers and/or oligomers containing hydroxyl groups, amino groups, epoxy groups and/or carboxyl groups. In the case of these two-component systems the component containing isocyanate groups and the second component are mixed immediately prior to application, normally with the aid of a mixing and metering system.

The principal advantage of hotmelt adhesives over other adhesive systems lies in their capacity to set very rapidly, and also in the absence of water and solvents from their composition. Corresponding moisture-curing polyurethane hotmelt adhesives for bonding a variety of substrate materials are already known.

For instance, DE-A-32 36 313 describes a hotmelt adhesive which comprises a prepolymeric isocyanate, a thermoplastic polymer, and a low molecular weight synthetic resin selected from the group consisting of ketone resins, ketone-aldehyde condensation resins and/or hydrogenation products of acetophenone condensation resins. The prepolymeric isocyanate comprises a reactive polyurethane prepolymer of an aromatic diisocyanate and/or a prepolymer of this diisocyanate with a short-chain diol and also of a polyether or polyester which besides OH groups also comprises a short-chain diol.

According to EP-A-248 658, polyurethane hotmelt adhesives are preparable from a reaction product of diisocyanates and crystalline polyester-diols, the latter being synthesized from symmetrical aromatic dicarboxylic acids and having an acid content of at least 50 mol %. In preferred embodiments the free isocyanate groups are blocked, by means of acetylacetone for example. This measure reduces the moisture sensitivity of the hotmelt adhesive and therefore raises its storage stability; conversely, however, the setting rate is substantially lowered, since the isocyanate group must first be converted back into its reactive form by means of a deblocking step, with a view to the application temperature.

EP 0293602 B1 describes compatible mixtures for forming reactive hotmelt adhesives based on polyurethanes comprising a reaction product of a polyalkylene polyol and an isocyanate and also thermoplastic polymers having reduced polarity. Specifically mention is made of polymers of ethylene-vinyl monomers that have a vinyl monomer content of about 1 to 45 mol %, polyolefin polymers, radial A-B-A block copolymers, A-(B-A)ₙ-B block copolymers or A-B-A block copolymers in combination with compatible tackifying resins. It is said that these adhesives have good heat stability, good initial adhesion, good storage stability and good curing through volume.

U.S. Pat. No. 4,775,719 describes a thermally stable, moisture-curing hotmelt, adhesive composition having a low viscosity, a very high initial strength and ultimate strength. This composition is said to comprise a liquid polyurethane prepolymer, an aromatic or aliphatic-aromatic tackifying resin, and a polymeric component comprising polyethylene-vinyl monomers, which is to have an ethylene fraction of up to 55% by weight.

U.S. Pat. No. 3,931,077 describes an adhesive composition comprising a reactive polyurethane prepolymer, a thermoplastic resin based on ethylene-vinyl acetate copolymers, ethylene-acrylic acid copolymers, ethylene-acrylate copolymers, atactic polypropylenes or linear polyethylene terephthalate polymers and also a tackifying resin from the group of the abietic acid resins (rosins), whose active hydrogen or double bonds have been wholly or partly removed by esterification, and also terpene-phenol copolymers.

DE-A-2014170 describes thermoplastic polyurethanes which can be used as hotmelt adhesives. These compositions are reaction products of a prepolymer containing isocyanate groups with an OH-terminated polyester, the intention being that the OH-terminated polyester should be used in excess. Accordingly a hotmelt adhesive of this kind is no longer able to moisture-cure with crosslinking.

WO 91/15530 describes a urethane hotmelt adhesive composition comprising an unreactive polyester/poly-ether copolymer and a polyisocyanate prepolymer formed from a polyol and polyfunctional isocyanate having an isocyanate functionality of 2 or more. In the polyester-polyether copolymer the acid unit is said to be predominantly a cyclic carboxylic acid. This hotmelt adhesive is said to have the characteristics of a thermoplastic hotmelt adhesive and of a reactive adhesive, to exhibit flexibility and to be able to be used for both adhesive functions and sealing functions. A disadvantage of such compositions is that they have a very high softening point and therefore require a very high melting temperature in order to liquefy the adhesive.

WO 01/96436 describes compositions comprising reaction products of a polyisocyanate with a polyester block copolymer and a process for preparing them. The carboxyl-terminated polyester block is said to be constructed from aliphatic dicarboxylic acids selected from adipic acid, pimelic acid, suberic acid, azelaic acid, sebacic acid, undecanedioic acid, dodecanedioic acid, or mixtures thereof and difunctional alcohols selected from butanediol, hexanediol, octanediol, decanediol, dodecanediol or mixtures thereof and at least one block is said to be formed by (—(CH₂)₄—O— (CH₂)₄—)ₒ, (—C₃H₆—O—C₃H₆—)ₒ, (—C₂H₄—O—C₂H₄—)ₚ, the radical of a polybutadiene, of a polycarbonate or of a polycaprolactone, or a combination thereof. These compositions are suitable for use as moisture-curing hotmelt adhesive. Where appropriate the hotmelt adhesive composition may further comprise a reaction product of a polyisocyanate with a polyester polyol and/or a reaction product of a polyisocyanate with a polyether polyol. Polyurethane hotmelt adhesive compositions of this kind are said to have good creep resistance values and interface adhesion values on plastics and to exhibit very high strength values.

WO01/46330 describes compositions comprising reaction products of a polyisocyanate with a polyester-polyether copolymer and a process for preparing them. The polyester-polyether copolymer is said to be constructed from the block of carboxyl-terminated polyester and the block of poly(oxytetramethylene) glycol, poly(oxypropylene) glycol, poly(oxyethylene) glycol or copolymers thereof. The carboxyl-terminated polyester block, according to the teaching of this specification, is constructed from aliphatic or aromatic dicarboxylic acids, selected from adipic acid, pimelic acid, suberic acid, azelaic acid, sebacic acid, undecanedioic acid, dodecanedioic acid, phthalic acid, terephthalic acid, isophthalic acid or mixtures thereof, and difunctional alcohols, selected from ethylene glycol, propylene glycol, butanediol, diethylene glycol, triethylene glycol, dipropylene glycol, tripropylene glycol, hexanediol, octanediol, decanediol, dodecanediol or mixtures thereof. These compositions are said to be suitable for use as moisture-curing hotmelt adhesives which exhibit good creep resistance values and interfacial adhesion values on plastics and have very high strength values.

### BRIEF SUMMARY OF THE INVENTION

In view of this prior art the inventors set themselves the object of providing an adhesive which has similar properties to a hotmelt adhesive but which is aftercrosslinking and requires low temperatures for melting.

The present invention provides an adhesive composition comprising
a.) a reaction product of a polyisocyanate in stoichiometric excess with a hydroxy-functional polyester-ether block copolymer based on aromatic dicarboxylic acids;
b.) optionally, a reaction product of a polyisocyanate with a polyester polyol;
c.) optionally, a reaction product of a polyisocyanate with a polyether polyol; and
d.) if desired, unreactive thermoplastic polymers; wherein at least one of b.) or c.) is present.

The present invention further provides for the use of such compositions for adhesively bonding flat laminated systems, e.g., kitchen worktops in the furniture industry, caravan side parts and panels in the construction industry, these adhesive compositions being especially suitable for substrates which withstand a very small degree of temperature load and for applications in which the adhesive must be applied over a large area.

### DETAILED DESCRIPTION OF CERTAIN EMBODIMENTS OF THE INVENTION

The aromatic dicarboxylic acids of the polyester-ether block copolymer are selected from terephthalic acid, isophthalic acid, phthalic acid, dibenzoic acid, bis(p-carboxyphenyl)methane, p-oxy(p-carboxyphenyl)benzoic acid, ethylenebis(p-oxybenzoic acid), ethylenebis(p-benzoic acid), tetramethylenebis(p-oxybenzoic acid), 1,5-naphthalenedicarboxylic acid, 2,6-naphthalene-dicarboxylic acid, 2,7-naphthalenedicarboxylic acid, phenanthrenedicarboxylic acid, anthracenedicarboxylic acid, 4,4′-sulfonyldibenzoic acid, indenedicarboxylic acid, and also their ring-substituted derivatives such as C₁-C₁₀ alkyl, halogen, alkoxy or aryl derivatives, p-(β-hydroxyethoxy)benzoic acid or mixtures thereof, the fraction of terephthalic acid preferably accounting for at least 75% by weight of the dicarboxylic acid mixture. If desired it is possible as well, proportionally, to use aliphatic or cycloaliphatic dicarboxylic acids for preparing the polyester-ether block copolymer.

As the short-chain diol component of the polyester-ether block copolymer use is made of C₂ to C₁₂ alkanediols, preferably ethylene glycol, propylene glycol, butanediol, hexanediol, octanediol or mixtures thereof.

As a polyether building block for the block copolymer use is made of polypropylene glycol, polyethylene glycol, copolymer of ethylene oxide and propylene oxide, poly(oxytetramethylene) glycol (PolyTHF), 1,2-polybutylene glycol, or mixtures thereof. Preferred molecular weight ranges for the polyetherol building blocks are between 400 and 20,000, preferably in the range from 1000 to 6000.

The hydroxy-functional polyester-ether block copolymers used in accordance with the invention have hydroxyl numbers of between 2 mg KOH/g and 50 mg KOH/g, preferably between 4 mg KOH/g and 20 mg KOH/g, very preferably between 5 mg KOH/g and 10 mg KOH/g.

As polyols for components b) and c) it is possible to use a multiplicity of polyhydroxy compounds of relatively high molecular weight. Polyols suitable with preference are the polyhydroxy compounds having two or three hydroxyl groups per molecule which are crystalline, glassily solid/amorphous or liquid at room temperature, in the molecular weight range from 400 to 20 000, preferably in the range from 1000 to 6000. Examples are difunctional and/or trifunctional polypropylene glycols, and random and/or block copolymers of ethylene oxide and propylene oxide can also be used. A further group of polyethers for preferred use are the polytetramethylene glycols (poly(oxytetramethylene) glycol, polyTHF), which are prepared, for example, by the acidic polymerization of tetrahydrofuran, the molecular weight range of the polytetramethylene glycols being between 600 and 6000, preferably in the range from 800 to 5000.

Of further suitability as polyols are the liquid, glassily amorphous or crystalline polyesters which can be prepared by condensing dicarboxylic and tricarboxylic acids, such as adipic acid, sebacic acid, glutaric acid, azelaic acid, suberic acid, undecanedioic acid, dodecanedioic acid, 3,3-dimethylglutaric acid, terephthalic acid, isophthalic acid, hexahydrophthalic acid, dimer fatty acid or their mixtures, for example, with low molecular weight diols and/or triols, such as ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimer fatty alcohol, glycerol, trimethylolpropane or mixtures thereof, for example.

A further group of the polyols to be used in accordance with the invention are the polyesters based on ε-caprolactone, also called “polycaprolactones”.

It is also possible, however, to use polyester polyols of oleochemical origin. Polyester polyols of this kind can be prepared, for example, by completely ring-opening epoxidized triglycerides of at an least partly olefinically unsaturated fatty-acid-containing fat mixture with one or more alcohols having 1 to 12 carbon atoms and subsequently partially transesterifying the triglyceride derivatives to give alkyl ester polyols having 1 to 12 carbon atoms in the alkyl radical. Further suitable polyols are polycarbonate polyols and dimer diols (Henkel) and also castor oil and its derivatives. The hydroxy-functional polybutadienes as well, such as are obtainable, for example, under the trade name “Poly-bd”, can also be used as polyols for the compositions of the invention, as can their hydrogenated analogues.

Of further suitability as polyols are acrylic ester copolymer polyols which are linear and/or have a low degree of branching and which can be prepared, for example, by the free-radical copolymerization of acrylic esters, and/or methacrylic esters, with hydroxy-functional acrylic acid and/or methacrylic acid compounds, such as hydroxyethyl (meth)acrylate or hydroxypropyl (meth)acrylate. On account of this preparation mode the hydroxyl groups in these polyols generally have a random distribution, so that these polyols are either linear polyols or polyols with a low degree of branching that have an average OH functionality. Although the difunctional compounds are preferred for the polyols it is also possible, at least in minor amounts, to use polyols of higher functionality.

As polyisocyanates it is possible in principle to use a multiplicity of aliphatic, cycloaliphatic or aromatic polyisocyanates.

Examples of suitable aromatic polyisocyanates are the following: all isomers of tolylene diisocyanate (TDI), either in isomerically pure form or as a mixture of two or more isomers, naphthalene 1,5-diisocyanate, diphenylmethane 4,4′-diisocyanate (MDI), diphenyl-methane 2,4′-diisocyanate, and also mixtures of the 4,4′-diphenylmethane diisocyanate with the 2,4′ isomer, or mixtures thereof with oligomers of higher functionality (known as crude MDI), xylylene diisocyanate (XDI), 4,4′-diphenyl dimethylmethane diisocyanate, di- and tetraalkyl diphenylmethane diisocyanate, 4,4′-dibenzyl diisocyanate, 1,3-phenylene diisocyanate, 1,4-phenylene diisocyanate. Examples of suitable cycloaliphatic polyisocyanates are the hydrogenation products of the aforementioned aromatic diisocyanates such as, for example, 4,4′-dicyclo-hexylmethane diisocyanate (H₁₂MDI), 1-isocyanatomethyl-3-isocyanato-1,5,5-trimethylcyclohexane (isophorone diisocyanate, IPDI), cyclohexane 1,4-diisocyanate, hydrogenated xylylene diisocyanate (H₆XDI), 1-methyl-2,4-diisocyanatocyclohexane, m- or p-tetramethylxylene diisocyanate (m-TMXDI, p-TMXDI) and dimer fatty acid diisocyanate. Examples of aliphatic polyisocyanates are tetramethoxybutane 1,4-diisocyanate, butane 1,4-diisocyanate, hexane 1,6-diisocyanate (HDI), 1,6-diisocyanato-2,2,4-trimethylhexane, 1,6-diisocyanato-2,4,4-trimethylhexane and also 1,12-dodecane diisocyanate (C₁₂DI), very particular preference being given to diphenylmethane 4,4′-diisocyanate, or diphenylmethane 2,4′-diisocyanate or the relatively high molecular weight adducts thereof with diols having molecular weights below 1000 in accordance with the teaching of WO01/40342 or of WO03/033562.

As unreactive thermoplastic polymers d) it is possible in this context to use thermoplastic polyurethanes, thermoplastic polyester block copolymers, thermoplastic polyetheramides or low molecular weight polymers of ethylenically unsaturated monomers. Specific examples thereof are (co)polymers of one or more of the following monomers: C₁-C₁₈ alkyl esters of acrylic acid or methacrylic acid, acrylic acid, methacrylic acid, ethylene, vinyl acetate, vinyl propionate, vinyl versatate, vinyl ethers, alkyl fumarates, alkyl maleates, styrene, alkylstyrene, acrylonitrile and/or butadiene or isoprene and also hydrogenation products of the last-mentioned diene copolymers, such as styrene-ethylene-propylene or styrene-ethylene-butylene diblock or triblock copolymers. Normally these thermoplastics have a relatively low molecular weight. Low molecular weight in this context denotes an average molecular weight below 60 000; preferably the molecular weight of such thermoplastic polymers is between 10 000 and 40 000. “Unreactive” for the purposes of this invention are all such thermoplastics which contain virtually no Zerewitinoff-active hydrogen.

The hotmelt adhesive compositions of the invention may further comprise tackifying resins, such as abietic acid, abietic esters, terpene resins, terpene-phenolic resins, poly-α-methylstyrene or aliphatic, aromatic or aromatic-aliphatic hydrocarbon resins or coumarone-indene resins. These tackifying resins may if desired contain active hydrogen atoms, so that during the reaction with the diisocyanates or polyisocyanates they too are incorporated into the binder matrix of the hotmelt adhesive. Specific examples thereof are hydroxy-functional esters of abietic acid or else hydroxylated terpene-phenolic resins. The hotmelt adhesive compositions may further comprise fillers (e.g. silicates, talc, calcium carbonates, clays or carbon black), or thixotropic agents (e.g. Bentones, pyrogenic silicas, urea derivatives, fibrillated fibers or short pulp fibers), color pastes or pigments, or conductivity additives such as conductive blacks, or lithium perchlorate.

Where appropriate the hotmelt adhesive compositions of the invention may further comprise plasticizers, provided these plasticizers do not adversely effect the functions of the other constituents. Mention may be made by way of example of the liquid phthalate plasticizers, plasticizers based on aromatic esters such as esters of benzoic acid, for example, or else solid plasticizers such as dicyclohexyl phthalate, cyclohexanedimethanol dibenzoate and the like. Additionally the compositions of the invention may comprise catalysts, stabilizers, antioxidants, UV absorbers, waxes or adhesion promoters (based on organofunctional silanes, for example) or migratable, adhesion-promoting polyisocyanates according to the teaching of WO 01/40342, and other conventional auxiliaries and additives.

The selection of the individual components of the adhesive composition is guided primarily by the planned fields of application for these adhesives. In general the reaction product b) and/or c) in the adhesive composition is intended to act as what is called a soft segment; this is intended to assist the phase separation of the hard segment from the reaction product a). The hard segment here is formed by the polyester moiety of the polyester-polyether (block) copolymer. For this reason the fraction of terephthalic acid in the carboxylic acid mixture of the polyether-polyester block copolymer should preferably be at least 75% by weight of the overall carboxylic acid mixture, and additionally the “soft segment” of the polyester-polyether block copolymer should be composed preferably of polyTHF, hydroxy-functional polybutadiene and/or hydrogenated hydroxy-functional polybutadiene.

As compared with the known state of the art the hotmelt adhesive compositions of the invention have the following advantages:

In order to obtain the same effect it is necessary for unreactive polyester-polyether block copolymers to have a substantially higher molecular weight, which automatically leads to a very much higher melting temperature of the hotmelt adhesive composition.

Because of the reactive isocyanate groups the polyester-polyether block copolymer reaction product is incorporated solidly into the adhesive matrix, leading to higher thermal stability and better hydrolysis resistance and better compatibility of the hotmelt adhesive compositions of the invention.

Preferred hotmelt adhesive compositions of the invention comprise the following constituents:
1. 5 to 50%, preferably 5 to 30%, more preferably 10 to 20% by weight of the reaction product of a polyisocyanate and the polyester-polyether block copolymer (component a)),
2. 5 to 60%, preferably 10 to 40% by weight of the reaction product of a polyisocyanate with a polyester polyol and/or with a polyether polyol (component b) and/or c)), it being possible for this reaction product also to be prepared from mixtures of polyester polyols and polyether polyols and polyisocyanates,
3. 0 to 30%, preferably 5 to 15% by weight of a thermoplastic polymer according to d),
4. 0 to 60%, preferably 5 to 40% by weight of a tackifying resin, and
5. if desired, further auxiliaries and additives selected from the group consisting of fillers, thixotropic agents, color pigments, conductivity additives, stabilizers and ageing inhibitors, and also adhesion promoter additives,
   the sum of all the constituents of the composition making 100% by weight.

The hotmelt adhesive compositions of the invention are particularly suitable for adhesively bonding flat lamination systems, examples being kitchen worktops in the furniture industry, caravan side parts and panels in the construction industry.

The examples below are intended to illustrate the invention, but the selection of the examples does not constitute any restriction on the scope of the subject matter of the invention. Within the compositions all amounts data are parts by weight unless stated otherwise.

### EXAMPLES

1. An OH-terminated block copolyester was prepared from 350 g of butane-1,4-diol, 1000 g of dimethyl terephthalate and 2000 g of polyTHF (molecular weight 1000). The result was a hydroxy-functional copolymer having the following characteristics:
   OH number 7 mg KOH/g, melting point 145° C., viscosity 19 000 mPas at 190° C. (Brookfield viscometer with Thermosel® apparatus)
2. In the same way a hydroxy-functional block copolymer was prepared from 1000 g of dimethyl terephthalate, 250 g of isophthalic acid, 450 g of butane-1,4-diol and 2000 g of polyTHF 1000 by condensation reaction, and had the following properties:
   OH number: 11 mg KOH/g, melting point 140° C., Shore D hardness 14, Shore A hardness 75
3. In the same way a hydroxy-functional block copolymer was formed from 1000 g of dimethyl terephthalate, 350 g of butane-1,4-diol and 2000 g of polyTHF 1000, having an OH number of 14 mg KOH/g, melting point of 140° C., viscosity of 24 000 mPa·s at 190° C., Shore D hardness of 20 and Shore A hardness of 81.
4. Preparation of a prepolymer from polyester polyol and polyether polyol
   From a mixture in a weight ratio of 1:2 of a partially crystalline hydroxy-functional polyester based on adipic acid and hexane diol and polyTHF (molecular weight 2000) with 4,4′-diphenylmethane diisocyanate, at an NCO—OH ratio of 2.1:1, a polyurethane prepolymer having ester and ether moieties was formed.
5. Preparation of a hotmelt adhesive
   A poly-α-methylstyrene (softening point, ring & ball, 99° C., molecular weight about 1400) was heated to 190° C. in a stirred tank; at that temperature the reaction product of the copolyester with the polyisocyanate according to examples 1 to 3 was dissolved fully with stirring in the poly-α-methylstyrene, and subsequently, with stirring and at the same temperature, an ethylene-vinyl acetate copolymer was added (vinyl acetate fraction: 50% melt index (MFI, ISO 1133): at 190° C./21.2 N: 3). When a fully homogeneous mixture had been obtained the prepolymer according to example 4 was added.

The viscosity, the increase in viscosity over time and at temperature load, and the peel strength at 90° C. were determined for each of the resultant hotmelt adhesive compositions and also for the comparative example based on the teaching of EP 0544672 B1.

Measurement Methods:

Viscosity: according to Brookfield with Thermosel® addition, spindle 27, 5 rpm Ageing took place by determination of the viscosity over 16 h, open, in the Brookfield viscometer at the stated temperature.

Peel Strength:

The adhesive was knife-coated (150 μm) onto an MDF (medium density fiberboard) test board. Subsequently test strips (2×12 cm, craft paper) were applied directly to the film of adhesive. By means of silicone paper a section of the film of adhesive was masked off beforehand to allow a spring balance or clamping jaws of the tensile testing machine to be fastened to the test strips. The test specimens were compressed at a pressure of 3 N/cm² for 10 seconds. They were stored in a drying cabinet at 90° C. for 5 minutes or 30 minutes and the peel strength was determined correspondingly.

Melting point: by means of Kofler heating bar

The experimental results are listed in the table below.

| | Com- | Exam- | Exam- | Exam- | Exam- | Exam- |
|---|---|---|---|---|---|---|
| | parative | ple 6 | ple 7 | ple 8 | ple 9 | ple 10 |
| KRISTALLEX | 40% | 40% | 40% | 40% | 40% | 40% |
| F 100 | | | | | | |
| HYTREL 3078 | 10% | | | | | |
| Polyester/ | | 10% | | | | |
| polyisocyanate | | | | | | |
| adduct from | | | | | | |
| example 1 | | | | | | |
| Polyester/ | | | 10% | | | |
| polyisocyanate | | | | | | |
| adduct from | | | | | | |
| example 1, | | | | | | |
| chain extended | | | | | | |
| NCO/OH ratio | | | | | | |
| 0.7/1 | | | | | | |
| Polyester/ | | | | 10% | | |
| polyisocyanate | | | | | | |
| adduct from | | | | | | |
| example 2 | | | | | | |
| Polyester/ | | | | | 10% | |
| polyisocyanate | | | | | | |
| adduct from | | | | | | |
| example 3 | | | | | | |
| Polyester/ | | | | | | 10% |
| polyisocyanate | | | | | | |
| adduct from | | | | | | |
| example 3 | | | | | | |
| chain extended | | | | | | |
| NCO/OH | | | | | | |
| ratio 0.9/1 | | | | | | |
| LEVAMELT | 10% | 10% | 10% | 10% | 10% | 10% |
| 500 | | | | | | |
| Prepolymer | 40% | 40% | 40% | 40% | 40% | 40% |
| from example 4 | | | | | | |
| Appearance | homo- | homo- | homo- | homo- | homo- | homo- |
| | geneous | geneous | geneous | geneous | geneous | geneous |
| Viscosity | 9000 | 11300 | 9200 | 8000 | 10800 | 11500 |
| (170°) | mPas | mPas | mPas | mPas | mPas | mPas |
| 16 h viscosity | 14000 | 15000 | 13800 | 13600 | 13900 | 14100 |
| (170°) | mPas | mPas | mPas | mPas | mPas | mPas |
| 90° C. test | 350 | 450 | 450 | 400 | 350 | 400 |
| after 5 min [g] | | | | | | |
| 90° C. test | 200 | 250 | 250 | 150 | 200 | 200 |
| after 30 min [g] | | | | | | |

KRISTALLEX F 100: poly-α-methylstyrene (softening point 99° C., MW 1400, Eastman)
LEVAMELT 500: ethylene-vinyl acetate copolymer (Bayer)
HYTREL 3078: polyether-ester block copolymer, MFI (melt flow index) 5.0 g/10 min at 190° C. and 2.16 kg weight, DuPont

1. A polyurethane hotmelt adhesive composition comprising
a.) a reaction product of at least one polyisocyanate in stoichiometric excess with at least one hydroxy-functional polyester-ether block copolymer based on one or more aromatic dicarboxylic acids;
b.) a reaction product of at least one polyisocyanate with at least one polyol selected from the group consisting of polyester polyols and polyether polyols.

2. The composition of claim 1, wherein the aromatic dicarboxylic acids of the polyester-ether block copolymer are selected from the group consisting of terephthalic acid, isophthalic acid, phthalic acid, dibenzoic acid, bis(p-carboxyphenyl)methane, p-oxy(p-carboxyphenyl)benzoic acid, ethylenebis(p-oxybenzoic acid), ethylenebis(p-benzoic acid), tetramethylenebis(p-oxybenzoic acid), 1,5-naphthalenedicarboxylic acid, 2,6-naphthalene-dicarboxylic acid, 2,7-naphthalenedicarboxylic acid, phenanthrenedicarboxylic acid, anthracene-dicarboxylic acid, 4,4′-sulfonyldibenzoic acid, indenedicarboxylic acid, ring-substituted derivatives thereof, p-(p-hydroxyethoxy)benzoic acid, and mixtures thereof.

3. The composition of claim 1, wherein terephthalic acid comprises at least 75% by weight of the aromatic dicarboxylic acids.

4. The composition of claim 1, wherein at least one aliphatic or cycloaliphatic dicarboxylic acid is used in combination with the one or more aromatic dicarboxylic acids to prepare the polyester-ether block copolymer.

5. The composition of claim 1, wherein at least one polyether selected from the group of polypropylene glycol, polyethylene glycol, copolymer of ethylene oxide and propylene oxide, poly(oxytetramethylene) glycol, 1,2-polybutylene glycol and mixtures thereof is used to prepare the polyester-ether block copolymer.

6. The composition of claim 1, wherein at least one short-chain diol selected from the group consisting of C₂ to C₁₂ alkanediols is used to prepare the polyester-ether block copolymer.

7. The composition of claim 1, said composition is comprised of a reaction product of at least one polyisocyanate with at least one polyester polyol selected from the group consisting of liquid, glassily amorphous and crystalline polyesters prepared by condensing dicarboxylic and/or tricarboxylic acids with low molecular weight diols and/or triols.

8. The composition of claim 1, wherein said composition is comprised of a reaction product of at least one polyisocyanate with at least one polyether polyol selected from the group consisting of difunctional and trifunctional polypropylene glycols, random and block copolymers of ethylene oxide and propylene oxide, poly(oxytetramethylene) glycol (polyTHF), 1,2-polybutylene glycol and mixtures thereof having an average molecular weight ranging from 400 to 20,000.

9. The composition of claim 1, additionally comprising at least one unreactive thermoplastic polymer having an average molecular weight below 60,000 selected from the group consisting of thermoplastic polyurethanes, thermoplastic polyester block copolymers, thermoplastic polyetheramides, (co)polymers of one or more of the following monomers: C₁-C₁₈ alkyl esters of acrylic acid or methacrylic acid, acrylic acid, methacrylic acid, ethylene, vinyl acetate, vinyl propionate, vinyl versatate, vinyl ethers, alkyl fumarates, alkyl maleates, styrene, alkylstyrene, acrylonitrile, butadiene and isoprene, and hydrogenation products of diene copolymers.

10. The composition of claim 1, additionally comprising at least one unreactive thermoplastic polymer.

11. The composition of claim 1, wherein at least one short-chain diol selected from the group consisting of ethylene glycol, propylene glycol, butanediol, hexanediol, and octanediol is used to prepare the polyester-ether block copolymer.

12. The composition of claim 1, additionally comprising at least one tackifying resin.

13. The composition of claim 1, said composition comprising 5 to 50% by weight of component a.) and 5 to 60% by weight of component b.).

14. The composition of claim 1, wherein the polyester-ether block copolymer has a hydroxyl number between 2 mg KOH/g and 50 mg KOH/g.

15. The composition of claim 1, wherein the polyester-ether block copolymer is prepared using one or more aromatic dicarboxylic acids with terephthalic acid comprising at least 75% by weight of the aromatic dicarboxylic acids, one or more short chain diols selected from the group consisting of ethylene glycol, propylene glycol, butanediol, hexanediol, and octanediol, and one or more polyether polyols selected from the group consisting of difunctional and trifunctional polypropylene glycols, random and block copolymers of ethylene oxide and propylene oxide, poly(oxytetramethylene) glycol (polyTHF), 1,2-polybutylene glycol and mixtures thereof having an average molecular weight ranging from 400 to 20,000.

16. The composition of claim 1, wherein the polyester-ether block copolymer has a hydroxyl number between 4 mg KOH/g and 20 mg KOH/g and is prepared using one or more aromatic dicarboxylic acids with terephthalic acid comprising at least 75% by weight of the aromatic dicarboxylic acids, butanediol, and poly(oxytetramethylene) glycol (polyTHF) having an average molecular weight ranging from 600 to 6000.

17. The composition of claim 1, additionally comprising an ethylene-vinyl acetate copolymer.

18. The composition of claim 1, wherein 4,4′-diphenylmethane diisocyanate is used to form the reaction product of component a).

19. The composition of claim 1, wherein component b.) is a reaction product of a diisocyanate and a mixture of at least one polyether polyol and at least one polyester polyol.

20. The composition of claim 1, said composition comprising 5 to 30% by weight of component a.), 5 to 60% by weight component b.), 5 to 15% by weight of at least one non-reactive thermoplastic polymer, and up to 60% by weight of at least one tackifying resin.
